(19) United States
(12) Patent Application Publication
(10) Pub. No.: US 2020/0052278 A1
(43) Pub. Date: Feb. 13, 2020

(54) METHOD FOR BONDING SEPARATORS, METHOD FOR MANUFACTURING ELECTROCHEMICAL DEVICE, AND ELECTROCHEMICAL DEVICE

(71) Applicant: Envision AESC Energy Devices Ltd., Sagamihara-shi, Kanagawa (JP)

(72) Inventors: Mayuko KISHI, Sagamihara-shi (JP); Naoyuki IWATA, Sagamihara-shi (JP)

(73) Assignee: Envision AESC Energy Devices Ltd., Sagamihara-shi, Kanagawa (JP)

(21) Appl. No.: 16/494,933

(22) PCT Filed: Dec. 27, 2017
(86) PCT No.: PCT/JP2017/047019

§ 371 Date: Sep. 17, 2019

(30) Foreign Application Priority Data
Mar. 31, 2017 (JP) 2017-071409

(51) Int. Cl. H01M 2/18; H01M 2/16; H01M 2/14

(52) U.S. Cl. CPC H01M 2/18; H01M 2/145; H01M 2/164

(57) ABSTRACT

A method for bonding separators (3) having a multilayer structure that comprises a substrate layer (3a) and a ceramic layer (3b), the ceramic layer (3b) being laminated on at least one surface of the substrate layer (3a) and having higher heat resistance properties than the substrate layer (3a), the method comprising steps of: applying an adhesive member (10) onto the ceramic layer (3b) and then peeling off the adhesive member (10) to remove a portion of the ceramic layer (3b) together with the adhesive member (10); and heating a portion of the separator (3), from which the ceramic layer (3b) has been removed, to heat-weld the separator (3) to other separator (3).

### TECHNICAL FIELD

This application is based upon and claims the benefit of priority from Japanese patent application No. 2017-71409 filed on Mar. 31, 2017, the disclosure of which is incorporated herein in its entirety by reference.

The present invention relates to a method for bonding separators, a method for manufacturing an electrochemical device, and an electrochemical device.

### BACKGROUND ART

An electrochemical device such as a secondary battery typically has a structure in which an electrode laminate body and an electrolyte are housed in an outer container. The electrode laminate body is formed of positive and negative electrodes. The positive electrode and the negative electrode are alternately laminated on each other with a separator interposed therebetween. The separator prevents the occurrence of an electrical short circuit caused by contact between the positive electrode and negative electrode. The separator is made from an insulating resin, for example, polypropylene.

With the higher performance and greater capacity of electrochemical devices in recent years, higher heat is generated during operation of the electrochemical device. The separator made of a resin such as polypropylene may not have sufficient heat resistance properties. Therefore, Patent Documents 1 and 2 disclose a ceramic separator having a multilayer structure in which an insulating ceramic layer is laminated on a resin substrate layer. Ceramic layer has higher heat resistance properties than resin.

### PRIOR ART DOCUMENTS

### Patent Documents

### Patent Document 1: Japanese Patent Application Laid-open No. 2013-161633

### Patent Document 2: Japanese Patent Application Laid-open No. 2015-72833

### SUMMARY OF THE INVENTION

### Problem to be Solved by the Invention

Ceramic separator described in Patent Documents 1 and 2 has higher heat resistance properties than a separator made only of resin. Ceramic separator can certainly prevent the occurrence of an electrical short-circuit between the positive electrode and negative electrode even when heat is generated by the electrochemical device.

However, it may be difficult to bond such ceramic separators to each other. For example, in order to certainly prevent the occurrence of an electrical short circuit and to facilitate precise assembly of an electrode laminate body, separators are formed in a bag-shape. One type of electrode, for example, positive electrode, is inserted in the bag-shaped separator. Then, the bag-shaped separator which accommodates one type of electrode is alternately stacked with the other type of electrode to form the electrode laminate body. In order to form such a bag-shaped separator, it is necessary to bond the outer peripheries of sheet-shaped separators that overlap each other, except for one portion of the outer peripheries. Resin separators can be easily bonded to each other by heat-welding. However, ceramic layers having high heat resistance properties are not amenable to heat-welding.

In the invention described in Patent Document 1, a ceramic layer is formed only in some portion on a resin layer. It is easy to bond resin layers to each other by heat welding at the portions where the ceramic layer is not formed. However, it is necessary to appropriately change the position where the ceramic layer is formed, that is an application position, depending on the required dimension and shape of the separator. Therefore, it is impossible to make and widely use a general-purpose ceramic separator sheet. Depending on the circumstances, it is necessary to custom design and manufacture a separator. As a result, the design and production of the separator are complicated and manufacturing costs increase.

In the invention described in Patent Document 2, strong local pressure and heat are applied to ceramic separator sheets which overlap each other. Ceramic layers are forced to move from pressurized portions toward the peripheries. Therefore, the resin layers come in direct contact with each other, and the resin layers are heat-welded. This method requires extremely high pressure and high heat to cause the ceramic layers to move. Therefore, this method requires a special device for generating a far greater amount of pressure and heat than is generated by a device used for heat-welding resin layers, for example, a hand sealer. As a result, this method may increase manufacturing cost.

It is therefore an object of the present invention to provide a method for bonding separators, a method for manufacturing an electrochemical device, and an electrochemical device, that enable separators having high heat resistance properties to be easily bonded to each other at low cost.

### Means for Solving the Problem

The present invention is characterized in that a method for bonding separators having a multilayer structure that comprises a substrate layer and a ceramic layer, the ceramic layer being laminated on at least one surface of the substrate layer and having higher heat resistance properties than the substrate layer,

the method comprising steps of:

applying an adhesive member onto the ceramic layer and then peeling off the adhesive member to remove a portion of the ceramic layer together with the adhesive member; and

heating a portion of the separator, from which the ceramic layer has been removed, to heat-weld the separator to other separator.

### Effect of the Invention

According to the present invention, it is possible to easily bond separators having high heat resistance properties to each other at low cost.

### BRIEF DESCRIPTION OF THE DRAWINGS

FIG. 1A is a schematic plan view of a secondary battery that is an example of the electrochemical device including the separators used in the present invention.

FIG. 1B is a cross-section view taken along line A-A of FIG. 1A.

FIG. 2 is a perspective view showing a bag-shaped separator of the secondary battery shown in FIGS. 1A and 1B.

FIG. 3A is a schematic cross-section view showing a step in the method for bonding separators of an exemplary embodiment of the present invention.

FIG. 3B is a schematic cross-section view showing a step following the step shown in FIG. 3A in the method for bonding separators of an exemplary embodiment of the present invention.

FIG. 3C is a schematic cross-section view showing a step following the step shown in FIG. 3B in the method for bonding separators of an exemplary embodiment of the present invention.

FIG. 3D is a schematic cross-section view showing a step following the step shown in FIG. 3C in the method for bonding separators of an exemplary embodiment of the present invention.

FIG. 4 is a schematic cross-section view showing a step of a modification of the method for bonding separators shown in FIGS. 3A-3D.

FIG. 5A is a schematic perspective view showing the state before bonding the separators in another exemplary embodiment of the present invention.

FIG. 5B is a schematic perspective view showing a step in the method for bonding separators of another exemplary embodiment of the present invention.

FIG. 5C is a schematic perspective view showing a step following the step shown in FIG. 5B in the method for bonding separators of another exemplary embodiment of the present invention.

FIG. 5D is a schematic perspective view and a schematic front view showing a step following the step shown in FIG. 5C in the method for bonding separators of another exemplary embodiment of the present invention.

FIG. 6A is a schematic perspective view showing a modification of the method for bonding separators shown in FIGS. 5A-5B.

FIG. 6B is a schematic perspective view showing a step following the step shown in FIG. 6A in the method for bonding separators shown in FIGS. 5A-5B.

FIG. 6C is a schematic perspective view and schematic front view showing a step following the step shown in FIG. 6B in the method for bonding separators shown in FIGS. 5A-5B.

### EXEMPLARY EMBODIMENTS OF THE INVENTION

Exemplary embodiments of the present invention will be described with reference to the attached drawings.

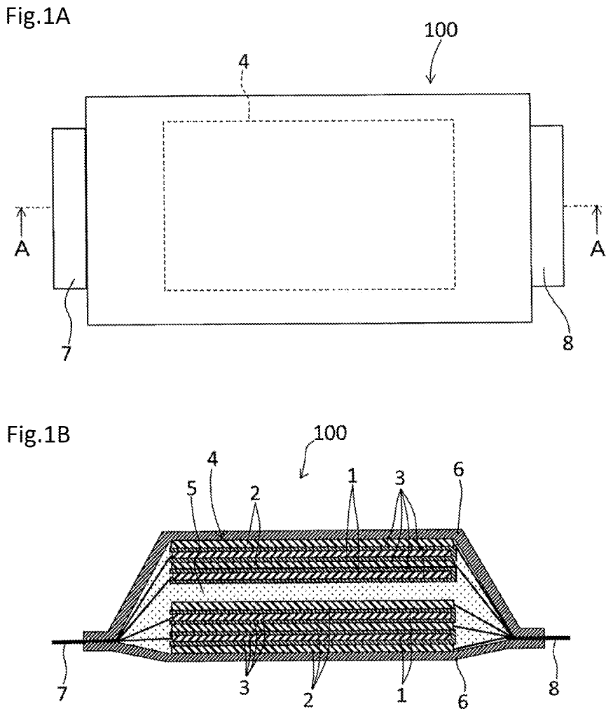

An electrochemical device including the separators which is used in the present invention will first be described. FIG. 1A is a schematic plan view of secondary battery 100 as viewed perpendicularly from above the principal flat surface. Secondary battery 100 is an example of an electrochemical device including a separator. FIG. 1B is a cross-section view taken along line A-A of FIG. 1A. Secondary battery 100 is provided with electrode laminate body 4 as a storage element. In electrode laminate body 4, two types of electrodes, i.e., positive electrodes 1 and negative electrodes 2, are alternately stacked on each other with separators 3 interposed therebetween. Electrode laminate body 4 is accommodated together with electrolyte 5 inside outer container 6 formed of a flexible laminate film.

One end portion of positive electrode terminal 7 is connected to positive electrodes 1 of electrode laminate body 4. One end portion of negative electrode terminal 8 is connected to negative electrodes 2. The other end portion of positive electrode terminal 7 and the other end portion of negative electrode terminal 8 extend to the outside from outer container 6 formed of flexible film. In FIG. 1B, a portion of the layers that make up electrode laminate body 4 is omitted in the drawing to show electrolyte 5. The omitted portion is in the middle position in the direction of thickness.

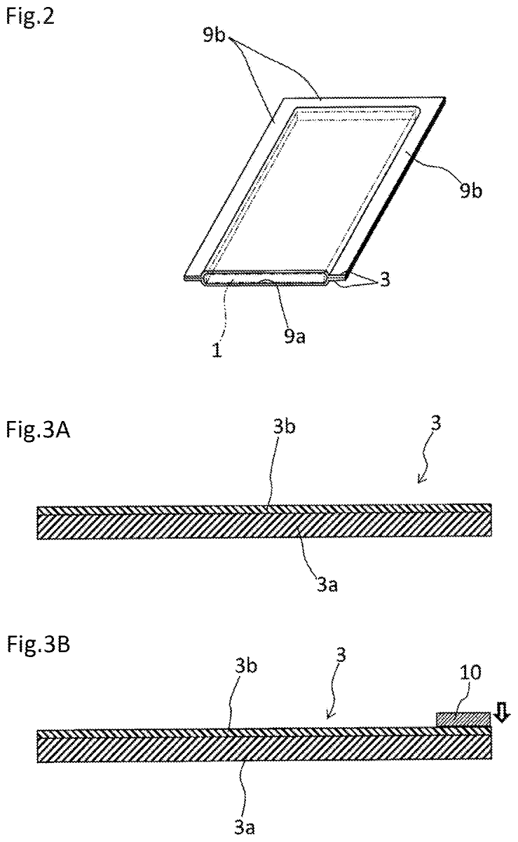

In the present exemplary embodiment, separators 3 are positioned above and below and thus sandwich one type of electrode, for example, positive electrode 1. These separators 3 are bonded to each other to form a bag shape. In other words, as shown in FIG. 2, the outer peripheries of a pair of sheet-shaped separators 3 overlap each other. Overlapping outer peripheries of sheet-shaped separators are bonded to each other except for one portion. As a result, a bag-shaped separator 3 having opening 9a and bonded portions 9b is formed from two sheet-shaped separators 3. The electrode, for example, positive electrode 1, is inserted from opening 9a and held in bag-shaped separator 3. The other electrodes, for example, negative electrodes 2, are positioned outside of bag-shaped separator 3. The electrode, for example, positive electrode 1, is not in contact with the other electrodes, for example, negative electrodes 2. Therefore, the occurrence of an electrical short circuit is prevented.

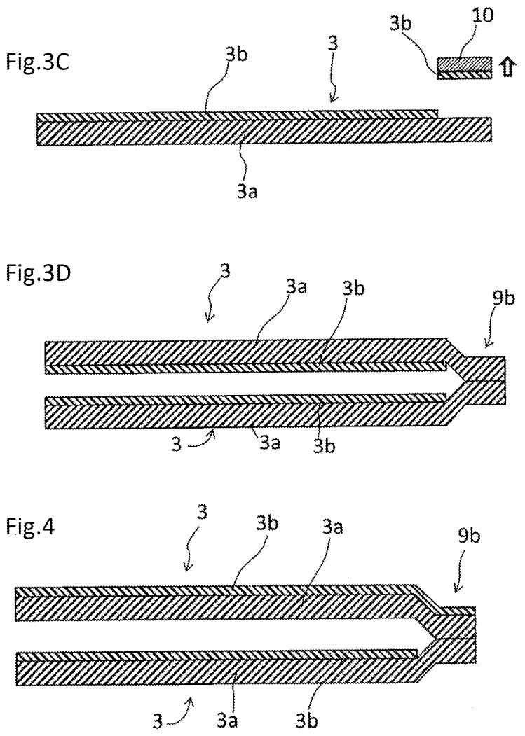

Separator 3 shown in FIG. 3A of the present exemplary embodiment is a ceramic separator having a sheet-shaped multilayer structure. Sheet-shaped separator 3 includes substrate layer 3a and ceramic layer 3b. Substrate layer 3a is a resin layer such as polypropylene layer. For the purpose of improving heat resistance properties of separator 3, ceramic layer 3b having higher heat resistance properties than resin layer 3a is laminated on at least one surface of resin layer 3a.

When a pair of sheet-shaped separator 3 is laminated and bonded to each other, it is difficult to bond ceramic layers 3b to each other by heat-welding, because ceramic layers 3b have high heat resistance properties. In the present exemplary embodiment, ceramic layers 3b of sheet-shaped separators 3 are partially removed to expose resin layer 3a. Exposed resin layers 3a are in contact with each other and bonded to each other by heat-welding. As a result, separators 3 can be easily and firmly joined together. In the portion to become bonded portion 9b, ceramic layer 3b was removed in advance.

As in Patent Document 1, ceramic layer 3b may not be formed at the positions to become bonded portions 9b at the time of fabricating separator 3. However, in this case, general-purpose separators for use in various electrochemical devices having different dimensions and different shapes, cannot be prepared. It is necessary to design and manufacture the dedicated separator for each electrochemical device, as appropriate. In other words, when manufacturing electrochemical devices having different dimensions and shapes, it is necessary to redo design and manufacture of the separator.

In the present exemplary embodiment, to prevent trouble and inefficiency, a general-purpose sheet-shaped separator having a large area is first formed. Ceramic layer 3b of this large-area separator is formed over the entire surface of resin layer 3a. This large-area separator is then cut into the sizes of each of sheet-shaped separators 3 shown in FIG. 3A. Then, as shown in FIG. 3B, an adhesive member, for example, adhesive tape 10, is applied to the portions of ceramic layer 3b to become bonded portions 9b. When adhesive tape 10 is subsequently peeled off, ceramic layer 3b is partially removed together with adhesive tape 10 to expose resin layer 3a as shown in FIG. 3C. Ceramic layer 3b is thus not present at the positions to become bonded portions 9b. Sheet-shaped separator 3 in which resin layer 3a is exposed at the positions to become bonded portions 9b is obtained. As shown in FIG. 3D, a pair of separators 3 is arranged such that exposed resin layers 3a are come into direct contact with each other. Then, the pair of sheet-shaped separators 3 is heated to occur heat-welding. As a result, a bag-shaped separator is formed from two sheet-shaped separators 3.

According to this method, heat-welding is easily carried out, because ceramic layer 3b was removed and resin layer 3a is exposed at the positions to become bonded portions 9b. Therefore, pressure and heat required for heat-welding do not have to be so high. By mere simple and easy operation of applying and then peeling off adhesive tape 10, heat-resistant ceramic separators 3 can be easily and firmly bonded to each other. The application and peeling off of adhesive tape 10 may be carried out manually, but can also be automated.

As a modification of the abovementioned method, although not shown in the drawings, an adhesive member, for example, adhesive tape 10, may be applied on ceramic layer 3b of long separator 3 before cutting. Then, applied adhesive tape 10 may be peeled off, to partially remove ceramic layer 3b. In this case, after ceramic layer 3b has been partially removed, the long separator is cut to obtain sheet-shaped separators 3 of determined size. Then, as in the abovementioned method, separators 3 are arranged such that exposed resin layers 3a are in direct contact with each other, and then are heated to heat-weld separators 3. As a result, a pair of separators 3 can constitute a bag-shaped separator. In this way, the same effect is obtained as in the abovementioned method by using adhesive tape 10 to partially remove ceramic layer 3b from long separators 3 and then to cut separators 3 into desired size.

Alternatively, in the example shown in FIG. 3D, a pair of separators 3 may be arranged such that ceramic layers 3b face each other and exposed resin layers 3a are in direct contact with each other. Then, a bag-shaped separator is formed by heat-welding of sheet-shaped separators. However, the present invention is not limited to this method.

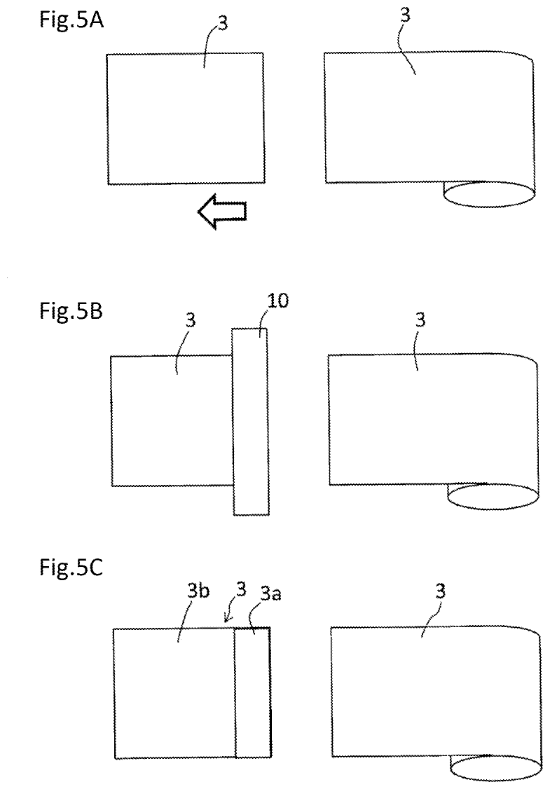

For example, as shown in FIG. 4, resin layer 3a is exposed on the upper surface of separator 3 where ceramic layer 3b has been partially removed by adhesive tape 10. Exposed resin layer 3a on the upper surface of separator 3 may face the lower surface of resin layer 3a of another separator 3. The lower surface of resin layer 3a is on the opposite side to ceramic layer 3b, in the other separator 3. Exposed resin layer 3a on the upper surface of separator 3 is in contact with the lower surface of resin layer 3a of the other separator 3. Then, bag-shaped separator is formed by heat-welding of resin layers 3a of separator 3 and the other separator 3. According to this method, it is possible to align a plurality of separators 3 in the same orientation in which ceramic layers 3b are positioned on the upper side and to carry out a bonding operation. Because it is not necessary to remove ceramic layer 3b of one of the separators that was referred to as the other separator 3 in the above description, the operation is easy.

Of course, separator 3 on the upper side and separator 3 on the lower side in FIG. 4 may be replaced with each other and reversed. In other words, although not shown in the drawings, separators 3 overlap with each other in a state in which ceramic layers 3b of separators 3 are on the lower side. Only ceramic layer 3b of upper separator 3 is partially removed. Ceramic layer 3b of lower separator 3 which is referred to as the other separator 3, is not removed. In this state, resin layer 3a exposed on the lower surface of upper separator 3 may be in direct contact with the upper surface of resin layer 3a of lower separator 3. The upper surface of resin layer 3a of lower separator 3 is on the side opposite to ceramic layer 3b. These resin layers 3a may be heat-welded each other so that sheet-shaped separators 3 constitute bag-shaped separator 3.

Alternatively, sheet-shaped separators 3 can also constitute bag-shaped separator 3 by the following steps. Ceramic layers 3b of separators 3 are partially removed. Separators 3 are oriented such that remaining ceramic layers 3b after partial removal are positioned outwardly. Resin layers 3a of a pair of separators 3 face each other and are in direct contact with each other. Then, parts of outer peripheries of resin layers 3a are heat-welded each other.

One type of electrode, for example, positive electrode 1 is inserted into bag-shaped separator 3 that have been fabricated in this way. Bag-shaped separator 3 having positive electrode 1 inserted therein and the other electrode, that is, negative electrode 2, are alternately stacked upon each other to constitute electrode laminate body 4. Positive electrode terminal 7 and negative electrode terminal 8 are connected to positive electrode 1 and negative electrode 2, respectively. This electrode laminate body 4 and electrolyte 5 are inserted into outer container 6 made of flexible film. Ends of electrode terminals 7 and 8 extend outwardly from outer container 6. Outer periphery of outer container 6 is sealed. Thus, secondary battery 100 that is an example of electrochemical device is completed, as shown in FIGS. 1A and 1B.

Bag-shaped separator 3 may be formed by bonding a pair of overlapping sheet-shaped separators 3 to each other as described above. However, bag-shaped separator 3 may also be formed by folding long sheet-shaped separator 3. In this case, one side of bag-shaped separator 3 is a folded portion. The other sides of bag-shaped separator 3 are made by bonding the overlapping portions of the outer peripheries of folded long sheet-shaped separator 3 to each other, except for one portion to become opening 9a. In this way, after long sheet-shaped separator 3 has been folded, two portions of folded long sheet-shaped separator 3 overlap each other. The outer peripheries of the two overlapping portions are bonded to each other. For the sake of convenience, the two overlapping portions, whose outer peripheries are bonded to each other, are regarded as “one separator” and “the other separator”.

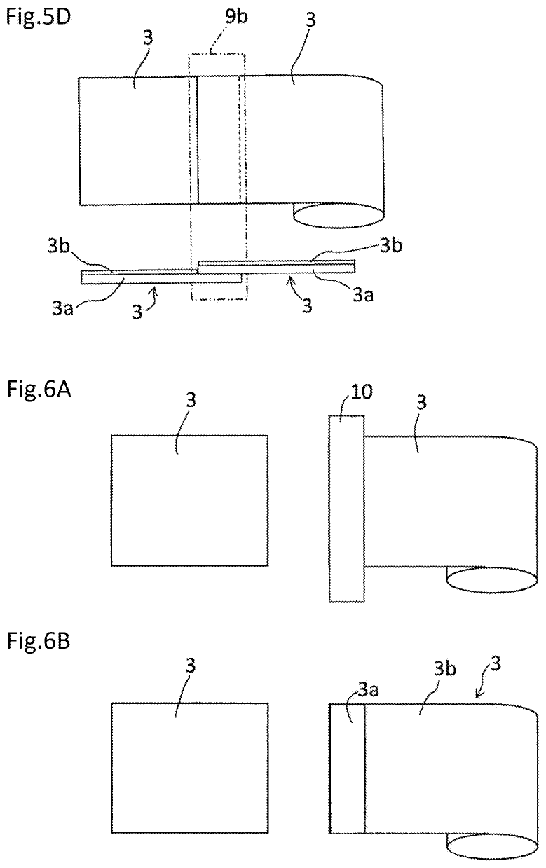

Another exemplary embodiment of the method for bonding separators of the present invention is next shown in FIGS. 5A-5D. In the present exemplary embodiment, long sheet-shaped separator 3 that has been wound in a roll shape is prepared to continuously manufacture or laminate a multiplicity of separators. This long separator 3 is successively supplied to a processing device, for example, a conveyance mechanism or cutting device of a lamination device, to perform successive processing. Processing device is not shown in the drawings. If the terminal of the currently processed separator roll and the beginning of the next separator roll are spliced together, it is possible to continue to process separators even after the process of one roll of separator 3 is completed, and therefore, it is possible to continuously process a plurality of separator rolls. When the terminal of the currently processed separator roll and the beginning of the next separator roll are spliced together, it is difficult to bond ceramic layers 3b to each other by heat-welding, as previously described.

In the present exemplary embodiment, as shown in FIG. 5B, an adhesive member such as adhesive tape 10 is applied to ceramic layer 3b of the terminal of currently processed separator roll 3 shown in FIG. 5A. Then, a part of ceramic layer 3b is removed by peeling off adhesive tape 10 as shown in FIG. 5C to expose resin layer 3a. As shown in FIG. 5D, exposed resin layer 3a makes contact with resin layer 3a at the beginning of next separator roll 3 which is not yet supplied to the processing device. Resin layers 3 that are in contact with each other are heat-welded. In this way, a plurality of rolls of separators can be easily spliced together and a multiplicity of rolls of separators can be continuously processed.

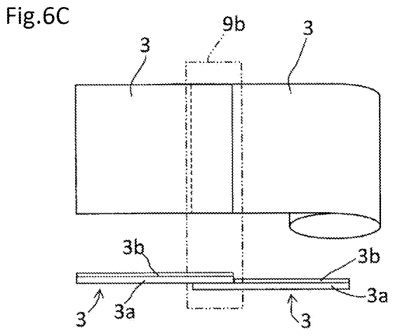

As a modification of the present exemplary embodiment, ceramic layer 3b at the beginning of the next separator roll 3 may be partially removed, and ceramic layer 3b of the terminal of currently processed separator roll 3 may not be removed. In other words, as shown in FIG. 6A, an adhesive member such as adhesive tape 10 is applied to ceramic layer 3b at the beginning of the next separator roll 3. As shown in FIG. 6B, adhesive tape 10 is then peeled off to partially remove ceramic layer 3b and to expose resin layer 3a. Then, as shown in FIG. 6C, exposed resin layer 3a makes contact with resin layer 3a of the terminal of currently processed separator 3 roll. Resin layers 3 that are in contact with each other are heat-welded. In this way, a plurality of rolls of separators can be easily spliced together and a multiplicity of rolls of separators can be continuously processed, too.

In another modification, both ceramic layer 3b of the terminal of currently processed separator roll 3 and ceramic layer 3b at the beginning of the next separator roll may be removed to expose resin layers 3a. In this case, resin layer 3a is exposed after ceramic layer 3b has been removed at the terminal of currently processed separator roll 3. Also, resin layer 3a is exposed after ceramic layer 3b is removed at the beginning next separator roll 3. Exposed resin layer 3a at the terminal of currently processed separator roll 3 and exposed resin layer 3a at the beginning of next separator roll 3 are heat-welded each other. Thus, separators of the two rolls are spliced together.

In order to form bag-shaped separator 3, sheet-shaped separators 3 are bonded to each other in the first exemplary embodiment. In order to continuously supply separators 3 from a plurality of rolls to the processing device or the like, separators 3 are bonded to each other in the second exemplary embodiment. It is difficult to heat-weld ceramic layers 3b to each other. Therefore, ceramic layer 3b is partially removed to expose resin layer 3a. Resin layers 3a are easily and firmly bonded to each other by heat-welding.

In the invention described in Patent Document 1, in a process for manufacturing separator 3, ceramic layer 3b is not formed at positions to become bonded portions 9b. However, such a process is problematic from the standpoint of general applicability. Therefore, it is preferable to form ceramic layer 3b over the entire surface of resin layer 3a of general-purpose separator 3, and then to remove a part of ceramic layer 3b to expose resin layer 3a. However, an easy method to remove a part of ceramic layer 3b has not been established. For example, according to the invention described in Patent Document 2, a part of ceramic layer 3b is forced to move by applying high pressure and high heat. Such a method to physically remove a part of ceramic layer 3a is problematic from the standpoint of manufacturing costs and the complexity of the operation. For example, in such a method, larger-scale device rather than a simple heat-welding device, such as a hand sealer or the like, is required.

In contrast, in the present invention, it is possible to realize firmly bonding separators to each other at a low cost by using an extremely easy and simple operation in which an adhesive member, such as adhesive tape 10, is first adhered and then peeled off. Therefore, the aforementioned problems are solved by the present invention. The prior-art document does not have a purpose increasing the reliability of bonding of separators 3 by such an easy and simple operation at all. Further, the prior document does not recognize the extremely high effectiveness of using adhesive member 10. The particular effect of enabling superior bonding of highly heat-resistant separators 3 by an extremely simple and low-cost method was first realized by means of the present invention. Still further, according to the present invention, because a ceramic layer is not present at bonded portions 9b of separators, there is no concern about contamination of the surroundings by the ceramic powder chipped from ceramic layer 3b during the bonding operation of separators. This is an additional advantage of the present invention.

Resin layer 3a as a substrate layer of separator 3 is composed mainly of a resin porous film, woven fabric, nonwoven fabric or the like. As an example of the resin component, polyolefin resin such as polypropylene or polyethylene, polyester resin, acryl resin, styrene resin, nylon resin, aramid resin (aromatic polyamide resin), polyimide resin and so on can be used. A microporous polyolefin film is particularly preferable because of its high ion permeability and its high isolation characteristics to physically isolate positive electrodes and negative electrodes from each other. Ceramic layer 3b is formed from an insulating ceramic that contains alumina, silica or the like. Ceramic layer 3b may be applied to resin layer 3a or may be adhered to resin layer 3a via an adhesive agent, for example, polyvinylidene fluoride (PVDF).

In the present invention, when adhesive tape 10 that has been adhered to ceramic layer 3b of separator 3 is then peeled off, a portion of ceramic layer 3b may remain on resin layer 3a without being completely peeled off. Even in such a case, there is no problem. If heat-welding can be realized in only the portions of resin layers 3a from which ceramic layer 3b was peeled off together with adhesive tape 10, superior bonding can be achieved. In addition, when ceramic layer 3b is adhered to resin layer 3a via an adhesive agent, the adhesive agent may remain after ceramic layer 3b has been peeled off together with adhesive tape 10. Even in such a case, there is no problem. Typically, an adhesive agent such as PVDF has a low melting point and its melting point is even lower than that of resin layer 3a in some cases. Therefore, the remaining adhesive agent does not hinder bonding.

In the structure shown in FIGS. 3A-6C, ceramic layer 3b is formed on only one surface of resin layer 3a of separator 3. However, ceramic layers 3b may be formed on both surfaces of resin layer 3a of separator 3. In this case, only ceramic layer 3b on the surface to be bonded to the other separator 3 should be partially removed. However, ceramic layers 3b on both surfaces may also be partially removed.

The present invention can be effectively applied not only to a secondary battery, for example, a lithium-ion secondary battery, but also to electrochemical devices other than batteries, such as capacitors or condensers.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

### EXPLANATION OF REFERENCE NUMBERS

100 secondary battery (electrochemical device)
1 positive electrode
2 negative electrode
3 separator
3a resin layer (substrate layer)
3b ceramic layer
4 electrode laminate body
5 electrolyte
6 outer container
7 positive electrode terminal
8 negative electrode terminal
9a opening
9b bonded portion
10 adhesive tape (adhesive member)

1. A method for bonding separators having a multilayer structure that comprises a substrate layer and a ceramic layer, the ceramic layer being laminated on at least one surface of the substrate layer and having higher heat resistance properties than the substrate layer,
the method comprising steps of:
applying an adhesive member onto the ceramic layer and then peeling off the adhesive member to remove a portion of the ceramic layer together with the adhesive member; and
heating a portion of the separator, from which the ceramic layer has been removed, to heat-weld the separator to other separator.

2. The method for bonding separators according to claim 1, wherein the substrate layer is exposed in the portion of the separator from which the ceramic layer has been removed.

3. The method for bonding separators according to claim 1, wherein the ceramic layer is adhered to the substrate layer by an adhesive agent, and the substrate layer or the adhesive agent is exposed in the portion of the separator from which the ceramic layer has been removed.

4. The method for bonding separators according to claim 1, wherein:
the ceramic layer is removed except for one portion in an outer periphery of the separator;
the separator overlaps the other separator; and
the portion of the outer periphery of the separator, from which the ceramic layer has been removed, is heat-welded to an outer periphery of the other separator to form a bag-shaped separator.

5. The method for bonding separators according to claim 4, wherein:
an adhesive member is adhered to the ceramic layer at an outer periphery of the other separator except for one portion, and then a portion of the ceramic layer is removed together with the adhesive member by peeling off the adhesive member; and
the portion of the outer periphery of the separator, from which the ceramic layer has been removed, overlaps and then is heat-welded on the portion of the outer periphery of the other separator, from which the ceramic layer has been removed, to form a bag-shaped separator.

6. The method for bonding separators according to claim 1, wherein:
the ceramic layer at beginning of the separator is removed; and
the portion at the beginning of the separator, from which the ceramic layer has been removed, overlaps and is heat-welded on the substrate layer of the terminal of the other separator to splice the separator and the other separator.

7. The method for bonding separators according to claim 1, wherein:
the ceramic layer at the terminal of the separator is removed; and
the portion of the terminal of the separator, from which the ceramic layer has been removed, overlaps and is heat-welded on the substrate layer at the beginning of the other separator to splice the separator and the other separator.

8. A method for manufacturing an electrochemical device that has an electrode laminate body in which two types of electrodes are alternately stacked on each other with separators interposed therebetween, and an outer container that accommodates the electrode laminate body together with an electrolyte;
the method comprising steps of:
inserting one type of electrode into a bag-shaped separator which was formed by the method for bonding of separators according to claim 4; and
alternately laminating the other type of electrode and the bag-shaped separators that each accommodate one type of electrode to form the electrode laminate body.

9. An electrochemical device comprising an electrode laminate body in which two types of electrodes are stacked on each other with separators interposed therebetween, and an outer container that accommodates the electrode laminate body together with an electrolyte; wherein:
the separators having a multilayer structure that comprises a substrate layer and a ceramic layer that is laminated on at least one surface of the substrate layer and that has higher heat resistance properties than the substrate layer;
the ceramic layer is removed except for one portion of the outer periphery of the separator;
the outer peripheries of the separators overlap at the outside of the electrodes,
the portions of the separators, from which the ceramic layers have been removed, are heat-welded together to form a bag-shaped separator, and
one type of electrode is accommodated in the bag-shaped separators.
